(19) United States
(12) Patent Application Publication
(10) Pub. No.: US 2002/0171904 A1
(43) Pub. Date: Nov. 21, 2002

(54) Method of forming an optical layer on a substrate

(76) Inventor: Gene H. Haertling, Albuquerque, NM (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/151,776

(22) Filed: May 20, 2002

Related U.S. Application Data
(60) Provisional application No. 60/292,387, filed on May 21, 2001.

(51) Int. Cl. G02F 1/03; G02F 1/07

(52) U.S. Cl. 359/245; 359/253

(57) ABSTRACT

A method of forming a substantially optically transmissive layer on a planar surface of a substrate comprises depositing layer(s) comprising at least one liquid precursor on the substrate. The deposited layers each have an inner side towards the planar surface and an outer side away from the planar surface. After depositing, contaminants are transported away from the inner side and along the outer side by positioning the substrate such that the planar surface faces downwards at a fixed angle. The fixed angle is made sufficient to achieve the transporting through the action of gravity. After the at least one liquid precursor is deposited and the transporting of contaminants step is performed, the liquid precursor layer(s) are heated. This method can be used to create useful optical features, such as switches.

### PRIORITY APPLICATION

This application claims priority under 35 U.S.C. §119(e) from U.S. Provisional Patent Application Ser. No. 60/292,387, filed May. 21, 2001, which is hereby incorporated herein by reference in its entirety.

### BACKGROUND OF THE INVENTION

1. Field of the Invention

This invention relates to a method for processing substrates to create substantially optically transmissive layers.

2. Description of Related Art

With the advent of the Internet and other data-intensive communications technologies, the demand for bandwidth, or data carrying capacity, has greatly increased. Various ways to improve the bandwidth of communications networks have been proposed and implemented. One particularly advantageous approach to increasing bandwidth is to use fiber-optic networks. Such networks may comprise a web of fiber-optic lines connected at signal processing nodes where an optical signal can be switched from one fiber-optic line to another. These nodes have historically employed electronic switches which require the optical signal to be converted into an electrical signal. Using these electrical switches in fiber optic networks is not ideal, however, because of the added steps of converting the optical signal into an electrical signal and subsequently converting the switched electrical signal back to an optical signal. Optical switches are therefore preferred for fiber optic networks.

Exemplary optical switches and other devices, which comprise electroptically active lead—lanthanum-zirconate-titantate (PLZT) are disclosed in U.S. patent application Ser. No. 08/959,778, filed on Oct. 29, 1997, now U.S. Pat. No. 6,310,712, U.S. patent application Ser. No. 10/013336 entitled “Electro-Optic Switching Assembly and Method”filed Nov. 5, 2001, now U.S. Pat. No. ______, and U.S. patent application Ser. No.______, (TOPTICS.004CP4), entitled “Optical Switching Network and Network Node and Method of Optical Switching”, filed May. 6, 2002 by Romanovsky, now U.S. Pat. No. ______, which are hereby incorporated herein by reference in their entirety. These optical switches can be fabricated by first depositing a layer comprising one or more liquid precursors on a substrate. The liquid precursors are liquid chemicals that are transformed to form another different material. Examples of processes involving liquid precursors include but are not limited to sol-gel processes and metal-organic deposition (MOD). Once the one or more liquid precursors are deposited, heating or sintering may be used to form a solid layer of PLZT. More specifically, sintering causes solidification or hardening as well as bonding to the nearest solid layer, which may comprise, for example, the substrate itself.

In forming PLZT on a substrate through a liquid precusor deposition process, it is preferable to remove any contaminants, i.e., particles other than PLZT. If the contaminants are not removed before the one or more liquid precursors are heated, the contaminants may be entrapped within the optical switch. The presence of contaminants in the PLZT layer of the optical switch degrades the performance of the switch, for example, by causing transmission losses. Thus, there is a need for a method of processing substrates which creates an optically transmissive layer while reducing the entrapping of contaminants, such as undesirable particulate within the layer.

### SUMMARY OF THE INVENTION

One aspect of the invention is a method of forming a substantially optically transmissive layer on a planar surface of a substrate. Successive layers including one or more liquid precursors are deposited on the substrate, such that each layer has an inner side towards the planar surface and an outer side away from the planar surface. Contaminants are transported away from the inner side and along the outer side by positioning the substrate with the planar surface facing downwards, and with the angle between (i) a vertical axis passing through the planar surface and (ii) the planar surface being sufficient to perform the transporting. The liquid precursor layers are heated after deposition to form the transmissive layer. In one embodiment, the angle is between 5 and 30 degrees, and more preferably between 5 and 15 degrees.

### BRIEF DESCRIPTION OF THE DRAWINGS

FIG. 1 is a schematic diagram of an apparatus adapted to process substrates which includes a workpiece holder that holds the substrate with a planar surface of the substrate facing downwards at a fixed angle.

FIG. 2 is a schematic elevation view of the workpiece holder of FIG. 1 showing the surface of the substrate facing downwards at an angle, and showing the substrate immersed in vat containing one or more liquid precursors.

FIG. 3 is an elevation view of an end portion of the workpiece holder showing a wire having a chisel end contact.

FIG. 4 is a schematic elevation view of the substrate positioned at an angle and coated with a liquid precursor layer after being immersed and withdrawn from the liquid precursor tank.

FIG. 4A is an enlarged view of the substrate of FIG. 4, showing the PLZT layer and the layer of liquid precursor(s) that has been deposited but not yet heated.

FIGS. 5 and 6 are a top and cross-sectional views of an optical switch that can be fabricated by filling a cavity with one or more liquid precursor that is subsequently hardened to form an optically transmissive material.

### DETAILED DESCRIPTION OF THE PREFERRED EMBODIMENT

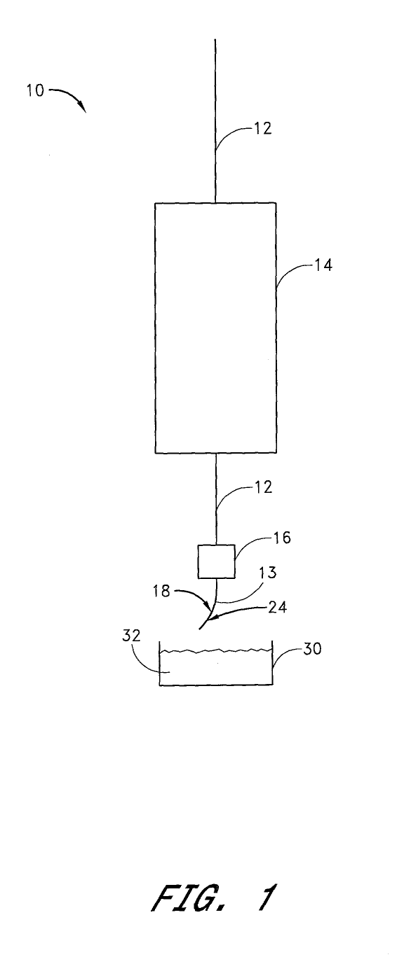

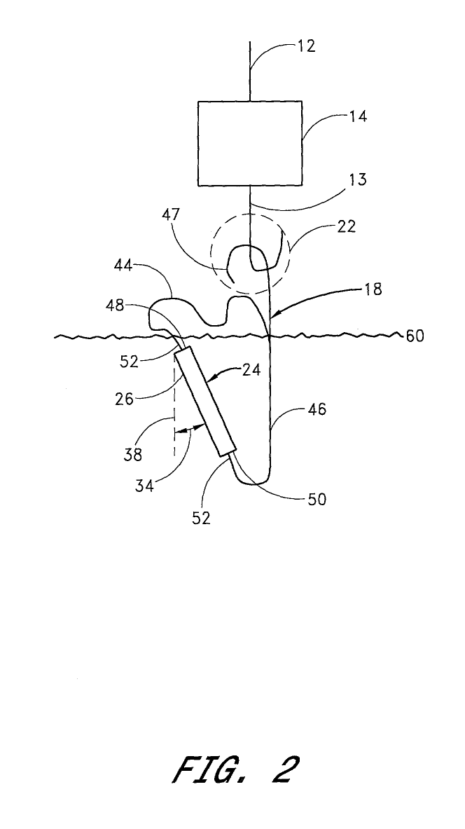

As shown in FIGS. 1 and 2, an apparatus 10 adapted to process substrates has a first suspension wire 12 which is arranged to extend downwardly through a curing device, such as a furnace 14. The suspension wire 12 may be comprised of any material which will not degrade when heated and cooled repeatedly, for example, inconel. A weight 16 is connected to the lower end of the first suspension wire 12. The weight 16 may be comprised of any material which can be repeatably heated and cooled while maintaining its structural integrity, i.e. while not generating particles or other contamination. One such material is ceramic.

A second suspension wire 13 is connected to and extends beneath the weight 16. The suspension wire 13 may also be comprised of any material which will not degrade when heated and cooled repeatedly, such as for example, inconel. A lower end of the wire 13 is connected to a workpiece holder 18 comprised of a wire having an upper section 44, a lower section 46, and a hooking section 47. The hooking section 47 hooks onto a mating hook on the lower end of the wire 13, thereby, forming a loose joint 22. However, any suitable connection between the suspension wire 13 and the workpiece holder 18 may be used. As with the wires 12, 13, the workpiece holder 18 is comprised of a material able to withstand repeated heating cycles without degrading. Such a material may include, for example, inconel. The apparatus 10 also has a tank 30 which contains a suitable volume of one or more liquid precursors 32 positioned beneath the workpiece holder 18.

As discussed above, a liquid precursor 32 is liquid chemical that is transformed into a material such as for example solid PLZT. One or more liquid precursors may form a layer of material when the solvent is evaporated, e.g., by heating. The residual layer preferably is a continuous film, which can take the form of solid polycrystalline or crystalline material. Processes that employ liquid precursors to form a material include but are not limited to sol-gel processes and metal-organic deposition (MOD). Hydrolysis condensation can also be used to produce a solid material from one or more liquid precursors.

The workpiece holder 18 is configured to hold a workpiece 24, such as a substrate, having a planar surface 26 upon which optical features may be created. The wire sections 44, 46 are comprised of a material that can undergo multiple heating and cooling cycles and that does not react with or substantially add contaminants to the one or more liquid precursors. In one embodiment, the material making up the upper section 44 is also manipulable by an operator, that is, the material is sufficiently pliable so that an operator can alter its overall shape manually. At the same time, the material making up sections 44 and 46 preferably has sufficient stiffness to provide a compressive force onto opposite edges 48 and 50 of workpiece 24. One such material is inconel. Other materials that are sufficiently strong and will not react with the one or more liquid precursors or otherwise contaminate them, such as stainless steel, are also suitable.

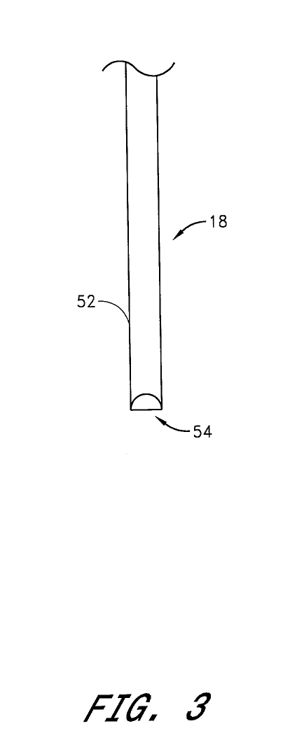

As shown in FIG. 3, the wire sections 44 and 46 have ends 52. These ends contact opposite edges 48 and 50 of the workpiece 24. The ends 52 are fashioned into suitable contact footprints, which are configured to prevent the workpiece 24 from twisting during processing (i.e. rotating about an axis passing through the centerline of both ends 52). One such contact footprint is a chisel contact 54. The chisel contact 54 provides line contact with the opposite edges 48 and 50 of the workpiece 24, and is formed as a tapered section for extending from the line contact portion until it reaches the thickness of the outer profile of the wire 44, 46. Other footprint geometries will also be suitable, such as an inverted “V” or fork which provides at least two-points of contact at each end 52. Also, a geometry providing a relatively large contact area may be used, so long as it provides sufficient friction between the workpiece 24 and the end 52 to prevent twisting relative to each other.

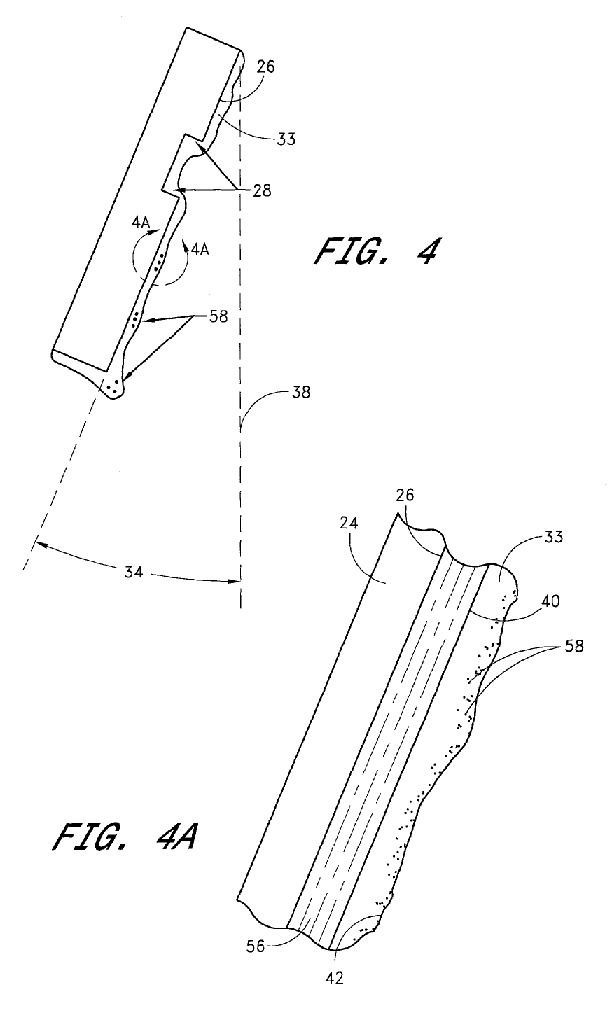

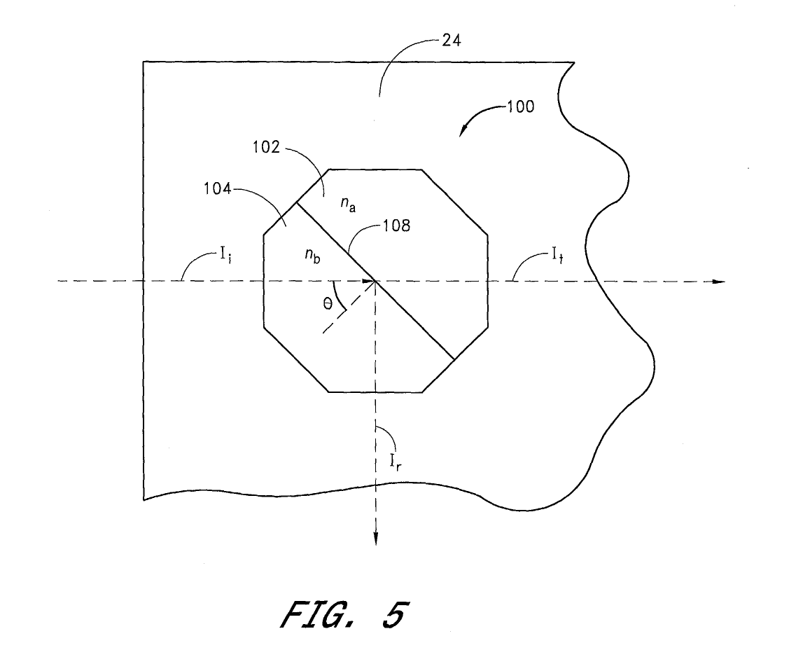

As shown in FIGS. 2 and 4, the workpiece 24 is held by the workpiece holder 18 at an angle 34 relative to vertical. Specifically, the angle 34 is the angle between the substantially planar surface 26 and a vertical axis 38 passing through the planar surface 26, where the planar surface is viewed from its edge.

The angle 34 can also be viewed as the angle between the vertical axis 38 and a shadow that would be cast by the vertical axis 38 onto the planar surface 26 when light rays are directed perpendicular to the surface 26. That shadow is referred to herein as an orthogonal projection of the axis 38 onto the planar surface 26.

The angle 34 is preferably between about 5° and 30°, and more preferably between about 5° and 20°. Most preferable, the angle is between 10° and 15°. This angle may depend on the characteristics of the liquid precursor(s) such as its viscosity, the ease of flow thereof, or of particles within a layer of one or more liquid precursors on the surface 26 of the substrate 24.

The workpiece 24 may have aspects of various kinds on the planar surface 26, such as a cavity 28, as shown in FIG. 4. The cavity 28 maybe configured such that when filled with an optical material, such as PLZT, the filled portion forms an optical element, such as an optical switch.

Various methods may be used to deposit liquid precursors onto the surface 26 of the workpiece 24. One preferred depositing method involves dipping the entire workpiece 24 into the tank 30 of one or more liquid precursors 32, as shown in FIGS. 1 and 2. As can be seen in FIGS. 4 and 4A this dipping creates a liquid precursor layer 33 on the surface 26, and in the cavity 28. Dipping is performed by lowering suspension wire 12, and the workpiece 24, which is attached to lowest end of the suspension wire 12 by workpiece holder 18, until the workpiece is in the liquid precursor tank 30. The workpiece 24 is preferably lowered past the surface, or dip line 60, of the liquid precursor solution or mixture 32 until the upper most end 48 is just below the dip line 60. In this way, most of the upper section 44 of the workpiece holder 18 does not contact the one or more liquid precursors 32, and thus is not a source of dripping liquid precursor when the workpiece 24 is lifted out of the liquid precursor tank 30. Although dipping is described with reference to FIGS. 1 and 2, the method of minimizing contamination in fabricating devices from liquid precursors is not so limited. Other ways of depositing PLZT onto the workpiece 24 include, for example, spraying an aerosol containing PLZT. With this method as well, the workpiece 24 is preferably tilted at an angle with respect to the vertical 38 such that contaminants are flowed away from the surface 26 and out of cavities 28 therein. If a similar geometry to that shown in FIGS. 1-2 and 4-4a is employed, however, the tank 30 filled with one or more liquid precursors 32 for dipping the substrate 24 will not be needed.

After immersing the workpiece 24 into the one or more liquid precursors 32, the workpiece holder 18 and workpiece are removed from the tank 30. The deposited liquid precursor layer 33 creates two interfaces on the working side of the workpiece: the interface between the liquid precursor(s) 33 and the workpiece 24, herein referred to as the inner side 40, and the interface between the liquid precursor(s) 33 and the ambient atmosphere which surrounds workpiece, hereinafter denoted the outer side 42. See FIG. 4A. The ambient atmosphere may be air or may be other gases that provide a favorable processing environment such as, e.g. high purity gas.

Upon removal of the workpiece 24, any contaminants 58, which may be in the liquid precursor layer 33 are transported away from the inner side 40, especially in any cavity 28 where the one or more liquid precursors have been deposited. The contaminants 58 are transported by positioning the substrate such that the planar surface 26 faces downward at the angle 34 as defined above. This angle may range between about 5° and 30°, preferably between about 5° and 15°. The angle is selected such that contaminants are removed from features such as cavities 28 and crevices in the workpiece 24 and flow or are transported therefrom toward the lower end of the piece. This angle 34 takes advantage of the force of gravity which acts on any contaminants 58, tending to pull them away from the inner side 40 and towards the outer side 42. When the contaminants are moved toward the outer side 42 they also tend to flow along with excess liquid precursor(s) 32 in the liquid precursor layer 33 towards the lower edge 50 of the workpiece 24.

After the contaminants have been transported, the liquid precursor layer 33 deposited upon the planar surface 26 of the workpiece 24 is sintered, such as by heating in the furnace 14. Sintering creates a solid, hard layer of PLZT 56 bonded to the surface of the workpiece 24, or in or on various workpiece surface features, such as cavities 28, crevices, openings, trenches, bumps, protrusions, peaks, and valleys.

Often more than a single layer is needed. In such cases, the above method can be repeated to create multiple layers 33. By depositing and sintering in an iterative fashion, a thicker layer of sintered PLZT 56 can be built up on the workpiece surface 26 or in the cavity 28. The multiple sintered layers making up the PLZT layer 56 are shown in FIG. 4A in broken lines.

By tilting the workpiece 24, contaminants 58 are removed from layers 33 prior to hardening of the one or more liquid precursors. Moreover, contaminants 58 can be removed from the surface features, such as cavities, crevices, pits, and valleys and a substantially contaminant-free layer can be formed therein as well as across the remainder of the workpiece 24. Multiple contaminant free-layers can be used to form contaminant-free multi-layers or contaminant-free devices. To form a device in the substrate 24, a cavity 28 or opening in the substrate is filled with one or more liquid precursors using the method described above so as to avoid accumulation of contaminants 58 therein, that is, the workpiece 24 is appropriately oriented such that the contaminants are transported away. The one or more liquid precursors are then hardened, for example, by sintering. At least one layer 33 is deposited but many layers may be applied so as to at least fill the cavity 28 or opening. The hardened excess material outside the cavity 28 or opening is then removed, for example, by polishing or etching down to the substrate surface 26. The hardened material then remains within the cavity 28. In this manner, for example, a solid portion of PLZT taking on the shape of the cavity 28 can be embedded in a substrate 24 such as, e.g., silicon or glass.

Various optical devices can be fabricated by depositing optically transmissive material into surface features formed on a substrate 24. For example, waveguides can be formed by filling trenches with a material that hardens to create an optically transmissive elongated structure imbedded in the substrate 24. This elongated structure preferably has optical characteristics different from those of the surrounding substrate 24. In particular, the index of refraction of the waveguide preferably is larger than that of the surrounding material that comprises the substrate 24. To build such a waveguide, a trench can be formed in the substrate 24 which may comprise for example, glass, slica, silicon, or quartz. The trench is then filled with a flowable material such as liquid precursor(s) that hardens to form an optically transmissive solid. This material may also comprise a glass, silica, or other material which is substantially optically transmissive but that can be deposited by a liquid precursor process. Excess maybe removed from the surface 26 of the substrate 24 such that only the hardened material within the trench remains. Preferably, the hardened material in the trench has a higher index than the substrate 24. So designed, this waveguide will confine light therein and can function as a pipe to transfer light coupled into the waveguide as is well known in the art.

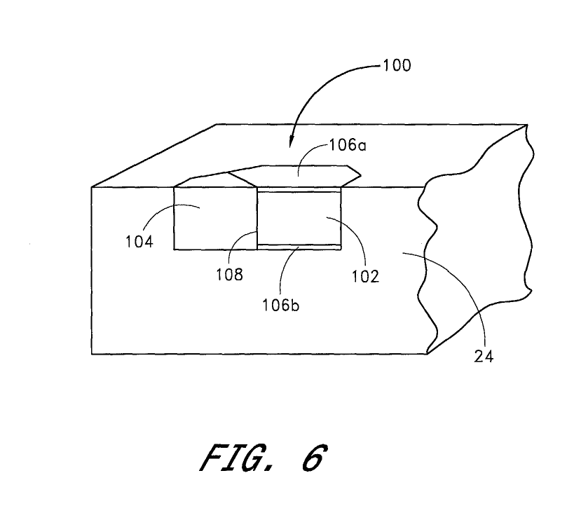

More complex components such as optical switches 100 like the total internal reflection (TIR) switch depicted in FIGS. 5 and 6 can also be similarly fabricated. This optical switch 100 comprises an electro-optically active portion 102 and an electro-optically inactive portion 104. A pair of electrodes 106a, 106b (see FIG. 6) are preferably disposed on opposite sides (e.g., the top and the bottom) of the active portion 102. A boundary 108 separates the two portions 102, 104. As discussed below, the characteristics of the boundary 108 are determined by the refractive indices of the two portions 102, 104.

The active portion 102 comprises an electro-optic material having an index of refraction that varies in response to application of an electric field. The inactive portion 104 comprises an electro-optic material that is not subject to the electric field. In one preferred embodiment, the refractive index of the active portion 102 matches that of the inactive portion 104 in the absence of an electric field so as to permit an incident light beam to propagate through the boundary 108 without substantial Fresnel reflection. However, when the switch 100 is exposed to an electric field, the refractive index of the active portion 102 is substantially changed. The refractive index of the inactive portion 104 remains substantially unchanged by the electric field. As such, the resulting difference in refractive indices between the two portions 102, 104 creates a refractive index interface at the boundary 108. The difference in the refractive indices of the two portions 102, 104 is sufficient to cause total internal reflection (TIR) of the light beam incident on the boundary 108 at an angle greater than a critical angle,θ_{c}.

As discussed herein, the boundary 108 is assumed to exist between the two portions 102, 104 at all times; this boundary, however, may not be physical but may be a function of the placement of the electrodes 106a and 106b. When the two refractive indices are the same, the boundary 108 is neither reflective or refractive and has no significant effect on the light passing through the boundary 108. When the refractive indices are different, the boundary 108 has the effects discussed below.

Namely, the refractive index interface is generated by applying a voltage between the electrodes 106a, 106b. As shown in FIG. 6, the electrodes 106a, 106b are preferably identically shaped to cover only the active portion 102 and are disposed on opposite sides of the active portion 102 so as to generate an electric field that is parallel to the boundary 108. The application of the electric field between the electrodes 106a and 106b lowers the refractive index of the active portion 102 so that the incident light beam Iᵢ that enters the deactivated portion 104 and strikes the boundary 108 is total internally reflected. Thus, the light signal is reflected at the boundary 108, remains in the inactive portion 104, but is deflected as shown by a reflected signal Iᵣ in FIG. 5.

The TIR switch 100 can be designed such that the two portions have similar or same indices of refraction when no electric field is applied to the electrodes. In this case, the light signal passes from the active portion 102 through the boundary 108 to the inactive portion 104 without experiencing significant reflection. The light signal then propagates through the inactive portion 104 and exits the switch 100 as illustrated by ray It.

Electro-optic PLZT can be used as the electro-optic material that forms the electro-optically active portion 102. The inactive portion 104 may also comprises a PLZT material. The optical switch 100 can be fabricated by filling a cavity in a substrate 24 with one or more liquid precursors that upon sintering becomes solid PLZT. The methods described above can be advantageously employed to create an optical switch 100 with a minimal amount of contaminants trapped therein. In particular, a cavity 28 can be formed in the substrate 24 and liquid precursor(s) of the PLZT can be deposited thereon, for example, by dipping with the substrate 24 properly oriented to minimize contamination into a vat 30 of one or more liquid precursors as discussed above. A furnace 14 can provide the sintering to produce hardened PLZT from the liquid precursor(s). Multiple applications may be necessary to completely fill the cavity 28 and form the optical switch 100. Polishing may be employed to remove excess PLZT. In this fashion, a substantially contamination-free optical switch 100 can be realized. This switch will be imbedded in the substrate 24 as shown in FIG. 6. Optical waveguides may also be formed in the substrate 24, as explained above, to carry light to and away from the optical switch 100.

Thus, a preferred method of forming an optical layer 33 on a substrate 24 according to the invention has been described herein. Modifications and additions to this preferred method will no doubt occur to those skilled in the art. For example, although the method has been described with respect to planar surfaces 24 and cavities 28, the method is not so limited, but rather may be effective in depositing liquid onto a variety of other surfaces as well. Further applications, additions and modifications may occur to those skilled in the art and the scope of the invention is not to be limited to the preferred embodiment described herein. Rather, the scope of the invention should be determined by reference to the following claims, along with the full scope of equivalents to which those claims are legally entitled.

What is claimed is:

1. A method of forming a substantially optically transmissive layer on a planar surface of a substrate comprising:
depositing successive layers including one or more liquid precursors on the substrate, each layer having an inner side towards the planar surface and an outer side away from the planar surface;
transporting contaminants away from said inner side and along the outer side, said transporting comprising:
positioning the substrate such that the planar surface faces downwards, and the angle between (i) a vertical axis passing through the planar surface and (ii) the planar surface is sufficient to perform said transporting; and
heating the liquid precursor layers after deposition.

2. The method of claim 1, further comprising positioning the substrate such that the angle is between five degrees and fifteen degrees.

3. The method of claim 1, further comprising positioning the substrate such that the angle between (i) an axis passing through the planar surface and (ii) an orthogonal projection of the axis onto the planar surface is between five degrees and fifteen degrees.

4. The method of claim 1, wherein said depositing further comprises dipping said substrate into said one or more liquid precursors.

5. The method of claim 1, wherein said depositing further comprises spraying said one or more liquid precursors in the form of an aero-sol onto said substrate.

6. The method of claim 1, wherein said positioning further comprises providing a workpiece holder having a pliable wire, and using the pliable wire to hold said workpiece.

7. The method of claim 5, wherein said providing step further comprises providing said workpiece holder formed of inconel.

8. The method of claim 1, further comprising determining fluid properties of the one or more liquid precursors, and performing said positioning step based on said fluid properties.

9. The method of claim 8, further comprising determining the surface geometry of said substrate, and performing said positioning based on said geometry.
